(19) United States
(12) Patent Application Publication
(10) Pub. No.: US 2002/0139906 A1
(43) Pub. Date: Oct. 3, 2002

(54) Height adjustment mechanism

(76) Inventor: Don-Tsun Pan, Tainan (TW)

Correspondence Address: Alan Kamrath, RIDER BENNETT EGAN & ARUNDEL, LLP, Suite 2000, 333 South Seventh Street, Minneapolis, MN, 55402, US

(21) Appl. No.: 09/824,598

(22) Filed: Apr. 2, 2001

(51) Int. Cl. F16M 11/20

(52) U.S. Cl. 248/188.1; 248/161

(57) ABSTRACT

A height adjustment mechanism is mounted under a chair or table. The mechanism comprises an adjustment lever extended from the top; a support tube having a longitudinal hole with a predetermined cross-section; a sliding tube with the predetermined cross-section and having an upper end coupled to the end of the lever, a lower end slidingly received in the longitudinal hole of the support tube, a longitudinal hole, and an aperture on the surface; a bar slidingly received in the sliding tube; and a sleeve having a spring depressible detent on the surface and a longitudinal slit such that the sleeve sandwiched between the bar and the sliding tube is flexible for providing a buffering; wherein the lever is operable to cause the spring depressible detent to fall into the aperture without turning chair or table while adjusting the height thereof.

### FIELD OF THE INVENTION

The present invention relates to height adjustment mechanisms and more particularly to an improved height adjustment mechanism of chair or table.

### BACKGROUND OF THE INVENTION

Conventionally, a swivel chair may be turned to adjust its height. However, this may cause the chair to collide with other objects while turning. Thus, it is desirable to provide a height adjustment mechanism of chair or table in which the chair or table is not turned while adjusting height in order to overcome the above drawback of prior art.

### SUMMARY OF THE INVENTION

It is an object of the present invention to provide a height adjustment mechanism mounted under a predetermined object comprising an adjustment lever extended from the top; a support tube having a longitudinal hole with a predetermined cross-section; a sliding tube with the predetermined cross-section and having an upper end coupled to the end of the lever, a lower end slidingly received in the longitudinal hole of the support tube, a longitudinal hole, and an aperture on the surface; a bar slidingly received in the sliding tube; and a sleeve having a spring depressible detent on the surface and a longitudinal slit such that the sleeve sandwiched between the bar and the sliding tube is flexible for providing a buffering; wherein the lever is operable to cause the spring depressible detent to fall into the aperture without turning the predetermined object while adjusting the height thereof.

In one aspect of the invention, the predetermined object is a chair.

In another aspect of the invention, the predetermined object is a table.

The above and other objects, features and advantages of the present invention will become apparent from the following detailed description taken with the accompanying drawings.

### BRIEF DESCRIPTION OF THE DRAWINGS

FIG. 1 is an exploded perspective view of a height adjustment mechanism mounted on a chair according to the invention;

FIG. 2 is a perspective view in part section of the assembled height adjustment mechanism of FIG. 1;

FIG. 3 is a view similar to FIG. 2 where the height adjustment mechanism is mounted on a table; and

FIG. 4 is a sectional view taken along line I-I of FIG. 3 or line II-II of FIG. 2.

### DETAILED DESCRIPTION OF THE PREFERRED EMBODIMENTS

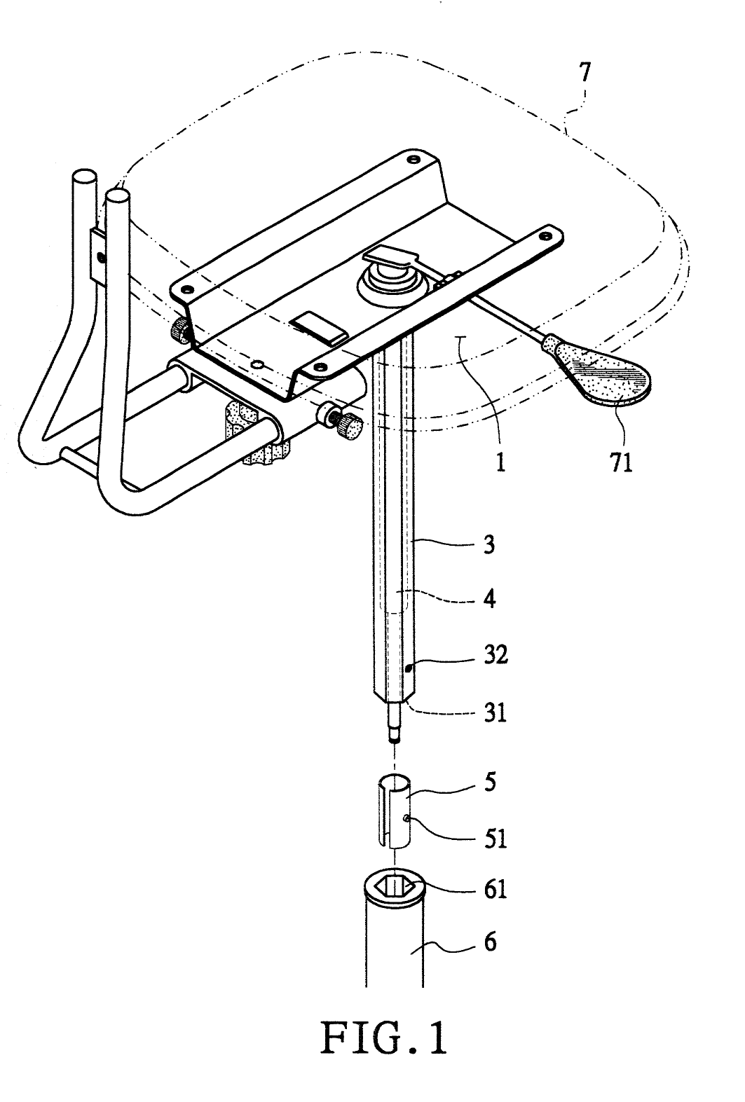

Referring to FIGS. 1 and 4, there is shown a height adjustment mechanism 1 in accordance with the invention. The height adjustment mechanism 1 is mounted under seat 7 of a chair and comprises an adjustment lever 71 extended from the top and beneath the seat 7, a support tube 6 projected on the base of chair and having a longitudinal hole 61 with a hexagonal cross-section, a sliding tube 3 with a hexagonal cross-section and having an upper end coupled to the end of lever 71, a lower end slidingly received in the hole 61 of support tube 6, a longitudinal hole 31, and an aperture 32 on the surface near the lower end, a bar 4 slidingly received in sliding tube 3, and a sleeve 5 having a spring depressible detent 51 on the surface and a longitudinal slit such that the sleeve 5 sandwiched between bar 4 and sliding tube 3 may flex for providing a buffering while adjusting the height of the chair or table.

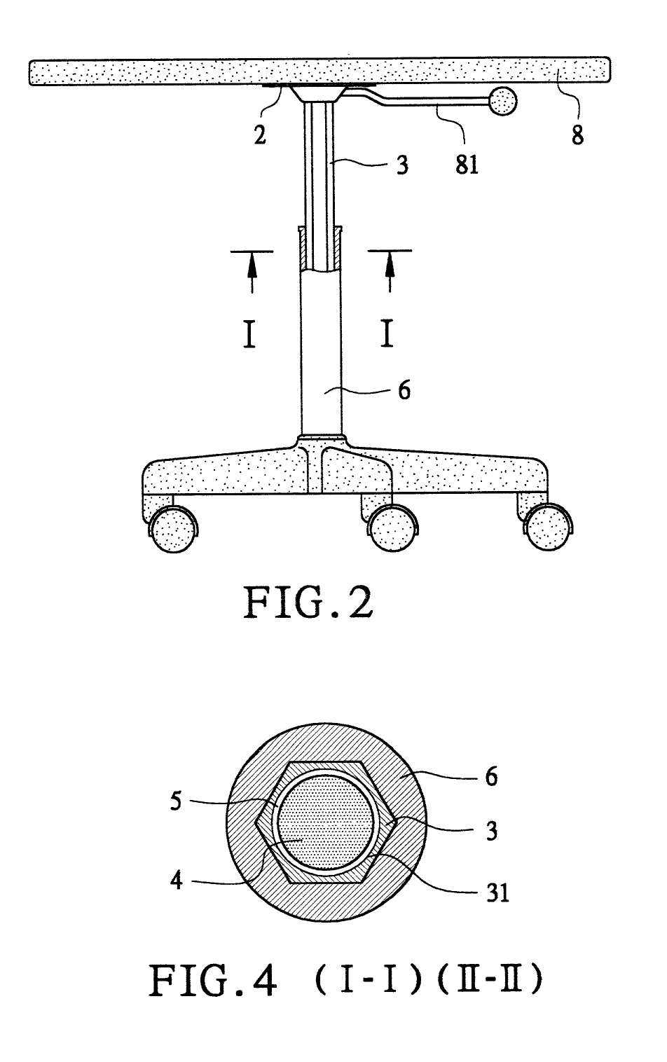

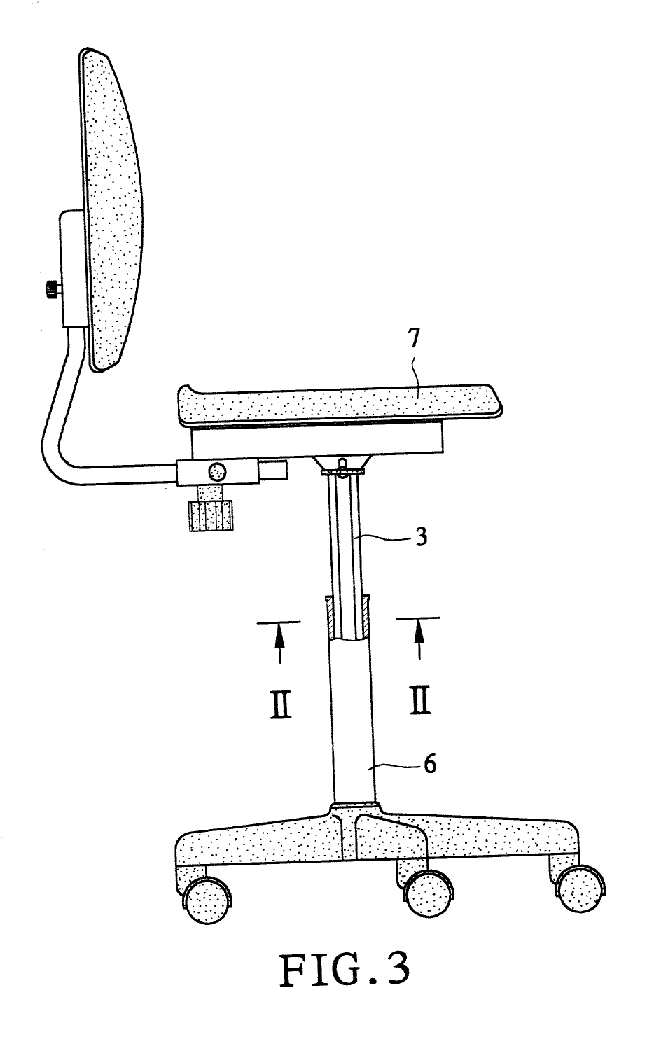

Referring to FIG. 2, in adjusting the height of the seat 7 of chair user may manipulate lever 71 to cause detent 51 to fall into aperture 32. Similarly, referring to FIG. 3, in adjusting the height of table 8 user may manipulate lever 81 to cause detent 51 to fall into aperture 32. It is important to note that the chair or table is not turned while adjusting the height thereof because the engagement of detent 51 and aperture 32 and the insertion of sliding tube 3 into the hole 61 of support tube 6 both having a hexagonal cross-section.

While the invention has been described by means of specific embodiments, numerous modifications and variations could be made thereto by those skilled in the art without departing from the scope and spirit of the invention set forth in the claims.

What is claimed is:

1 A height adjustment mechanism mounted under a predetermined object comprising:
an adjustment lever extended from said top;
a support tube having a longitudinal hole with a predetermined cross-section;
a sliding tube with said predetermined cross-section and having an upper end coupled to said end of said lever, a lower end slidingly received in said longitudinal hole of said support tube, a longitudinal hole, and an aperture on said surface;
a bar slidingly received in said sliding tube; and
a sleeve having a spring depressible detent on said surface and a longitudinal slit such that said sleeve sandwiched between said bar and said sliding tube is flexible for providing a buffering;
wherein said lever is operable to cause said spring depressible detent to fall into said aperture without turning said predetermined object while adjusting said height thereof.

2. The height adjustment mechanism of claim 1, wherein said predetermined object is a chair.

3. The height adjustment mechanism of claim 1, wherein said predetermined object is a table.
